(19) United States
(12) Patent Application Publication
(10) Pub. No.: US 2017/0329918 A1
(43) Pub. Date: Nov. 16, 2017

(54) INTERNET OF THINGS BASED MONITORING AND ASSESSMENT PLATFORM

(71) Applicant: Smartylab Corporation, Seoul (KR)

(72) Inventors: Soo Dong KIM, Seoul (KR); Hyun Jung LA, Seoul (KR)

(21) Appl. No.: 15/233,666

(22) Filed: Aug. 10, 2016

(30) Foreign Application Priority Data
May 10, 2016 (KR) 10-2016-0056857

(51) Int. Cl. G06F 19/00; G06F 17/30

(52) U.S. Cl. CPC G06F 19/3406; G06F 19/3431; G06F 17/30292; G06F 17/30321; G06F 17/3053

(57) ABSTRACT

Provided is an internet of things based health monitoring and assessment platform including: a health context acquirer configured to acquire health contexts from sensors of one or more IoT devices; a user manager configured to store and manage information on a user; a health context manager configured to store and manage the health contexts acquired from the health context acquirer; a health context normalizer configured to convert and normalize the values of the health contexts acquired from the health context acquirer to converted values between 0 and 1, in which when the value of the health context belongs to a normal range, the converted value is 1 and the converted value has a value closer to 0 as farther away from the normal range; and a health index calculator configured to calculate health indexes expressing a body health status in one aspect, in which manage information on the health context for each health index and a weight set for each health context according to an importance in which each health context is related with the health index, and calculates the heat indexes by multiplying the converted value of the health context, which is converted by the health context normalizer by the weight.

### CROSS-REFERENCE TO RELATED APPLICATION(S)

This application claims benefit of priority to Korean Patent Application No. 10-2016-0056857 filed on May 10, 2016 in the Korean Intellectual Property Office, the disclosure of which is incorporated herein by reference in its entirety.

### BACKGROUND

### 1. Field

The present invention relates to a technique for a health monitoring and assessment platform, and more particularly, to an internet of things based health monitoring and assessment platform capable of monitoring health and assessing a health status by using an IoT device of an individual user.

### 2. Description of Related Art

An internet of things (IoT) corresponding to intelligent technology and service which communicate information between a person and an object and between objects by connecting all things based on the internet is under the spotlight. Even in a medical field, various types of IoT devices which measure various body information including blood pressure, pulse, oxygen saturation, body fat mass, electroencephalogram (EEG), electrocardiogram (ECG), electromyogram (EMG), and the like are developed to be used for collecting personal health information.

Accordingly, it is easier to measure a health status using the health context collected by the personal IoT devices and diagnose diseases, and efforts for monitoring the health with software and diagnosing the diseases by analyzing the collected health context have be continued. As such, each personal medical diagnosis can determine the health status while burdening very little cost anytime and anywhere to solve the problems of the diagnosis by existing medical institutions, and thus recently, a digital healthcare service field has emerged as a key application domain using the internet of things computing.

However, in the case of non-professionals without medical knowledge, even though health information is measured by the personal IoT devices, it is difficult to determine exactly the health status by using the measurement values.

Further, an application or a system for monitoring personal health and assessing the health status has a high difficulty of development because a design of hardware and software is determined according to health assessment items.

As the related art related with this, a system of monitoring the personal health status and a system of assessing the personal health status are proposed.

First, as the system of monitoring the personal health status described above, in Korea Patent Registration No. 10-0821945, a system for monitoring health, wellness, and fitness which induces information regarding calories, metabolic rate, stress level, and the like from measurement values of sensors for heart rate, ECG, respiration rate, body temperature, EMG, EEG, ECG, and the like and outputs the information to be easily understood by a user is published. In Korea Patent Registration No. 10-1584623, a system and a method for providing a health management service which can prepare an evaluation criteria capable of evaluating a change in heath status before and after receiving the health management service and determine a meaningful change in health status before and after the provided health management service is published.

However, in Korea Patent Registration No. 10-0821945 described above, since processed information which may be analyzed based on types of predefined health information is listed, other types of health information are not considered and a detailed design content for how the information is processed is not described, and in Korea Patent Registration No. 10-1584623 described above, there is a limit in a limited analysis scheme of statistically processing index values input by many users.

Further, as the system for assessing the personal health status, in Korea Patent Application Publication No. 10-2011-0123754, a method and an apparatus for assessing vascular health using conductivity measurements to assess vascular health and diagnose vascular conditions are published, and in Korea Patent Registration No. 10-1510600, a bigdata health record system which allows a user to input various health information through a terminal thereof, assesses a health age, a stroke risk, a risk of obesity, a metabolic syndrome risk, and the like based thereon, and stores all data in cloud so that a Cohort research method of analyzing epidemiological data may be applied well is published.

However, in Korea Patent Application Publication No. 10-2011-0123754 described above, the content is limited to a hardware design for assessing the vascular health, and in Korea Patent Registration No. 10-1510600 described above, information directly input by the user's terminal and information measured in medical institutions are used. Thus, on the basis of an epidemiological research method called a Cohort method other than the health information acquired in the personal IoT device, whether a specific disease is caused is verified based on information of various groups and thus the patents are not applied to the personal health monitoring well.

### SUMMARY

An object of the present invention is to provide an internet of things based health monitoring and assessment platform which can monitor and assess the personal health by using the health information acquired from various IoT devices to be a great help in personal health promotion, is universally designed to collect various health information from heterogeneous IoT devices, and has an excellent extension to add a sensor of a new type of IoT device or a health context.

Further, regardless of a type of IoT device, a system configured by hardware, software, and cloud for health monitoring and assessment using the various collected personal health information can be developed with low cost and high efficiency.

An aspect of the present invention provides an internet of things based health monitoring and assessment platform including: a health context acquirer configured to acquire health contexts from sensors of one or more IoT devices; a user manager configured to store and manage information on a user; a health context manager configured to store and manage the health contexts acquired from the health context acquirer; a health context normalizer configured to convert and normalize the values of the health contexts acquired from the health context acquirer to converted values between 0 and 1, in which when the value of the health context belongs to a normal range, the converted value is 1 and the converted value has a value closer to 0 as farther away from the normal range; and a health index calculator configured to calculate health indexes expressing a body health status in one aspect, in which manage information on the health context for each health index and a weight set for each health context according to an importance in which each health context is related with the health index, and calculates the heat indexes by multiplying the converted value of the health context, which is converted by the health context normalizer by the weight.

The health context acquirer may include: A sensor interface defining a function required to read and receive values of the health contexts from sensors provided in various types of IoT devices; a connection interface defining functions required to connect the sensors through a specific network protocol; and a data fetch scheme interface defining functions required for acquiring values of the health context from the sensor of the IoT device by using pulling and pushing data acquiring methods.

The health context acquirer may add an interface suitable for a new sensor type by extending the connection interface and extending one or all of lower interfaces of the data fetch scheme interface when a new type sensor of the IoT device is verified and added.

The health context normalizer may include: a collection unit collecting health measurement information required for calculation of the converted value of the health context to be normalized; a load unit loading a rule required for normalization; and a normalizer normalizing a value of the health context suitable for the rule to convert the value to a converted value between 0 and 1.

The health index calculator may calculate the value of the health index as a value between 0 and 1 when multiplying a weight by the value converted in the health context normalizer and between 0 and 10 when multiplying 10 thereby again.

The health context normalizer may be designed by applying a template method pattern, and the health index calculator may be designed by applying a strategy pattern.

The health index calculator may calculate a health index without correction of an existing source code when the new type of health context and the corresponding weight are added, in the case where a new type of health context is added.

The health index calculator may calculate and average a plurality of health index values, respectively to determine the entire health status of the user.

The platform may have a database schema structure in which various data acquired from the sensors of the IoT devices with heterogeneity are separately stored in a plurality of tables by considering versatility, common information of IoT devices, dependent information to an IoT device object, and sensor information are separately stored in tables of a device model, a device item, and a sensor, respectively, and the acquired health context information, the acquired health context value, and a measurement unit are separately stored in each table of Measurement and MeasurementData.

According to the exemplary embodiments of the present invention, it is possible to monitor and assess the personal health by using the health information acquired from various IoT devices to be a great help in personal health promotion, be universally designed to collect various health information from heterogeneous IoT devices, and have an excellent extension to add a sensor of a new type of IoT device or a health context.

Further, regardless of a type of IoT device, a system configured by hardware, software, and cloud for health monitoring and assessment using the various collected personal health information can be developed with low cost and high efficiency.

### BRIEF DESCRIPTION OF DRAWINGS

The above and other aspects, features and other advantages of the present invention will be more clearly understood from the following detailed description taken in conjunction with the accompanying drawings, in which:

FIG. 1 is a diagram illustrating an example of a health index which may be calculated by considering various types of health contexts in a health assessment model;

FIG. 2 is a diagram illustrating an internet of things based health monitoring and assessment model platform according to an exemplary embodiment of the present invention;

FIG. 3 is a diagram illustrating a design model of a health context acquirer according to the exemplary embodiment of the present invention;

FIG. 4 is a diagram illustrating a design model of a health context normalizer and a health index calculator according to the exemplary embodiment of the present invention;

FIG. 5 is a diagram illustrating a database schema according to the exemplary embodiment of the present invention; and

FIG. 6 is a diagram illustrating an application example of the internet of things based health monitoring and assessment model platform according to the exemplary embodiment of the present invention.

### DETAILED DESCRIPTION

Hereinafter, a detailed system for implementing an internet of things based health monitoring and assessment model platform according to the present invention will be described in detail based on exemplary embodiments with reference to the accompanying drawings.

The internet of things based health monitoring and assessment model platform according to the present invention can monitor a health and assess a health status by using an IoT device of an individual user. To this end, first, a model of designing of hardware and software platform required when defining a health index calculation matrix and assessing a personal health status in various aspects based on the health index is proposed as a universal health assessment model.

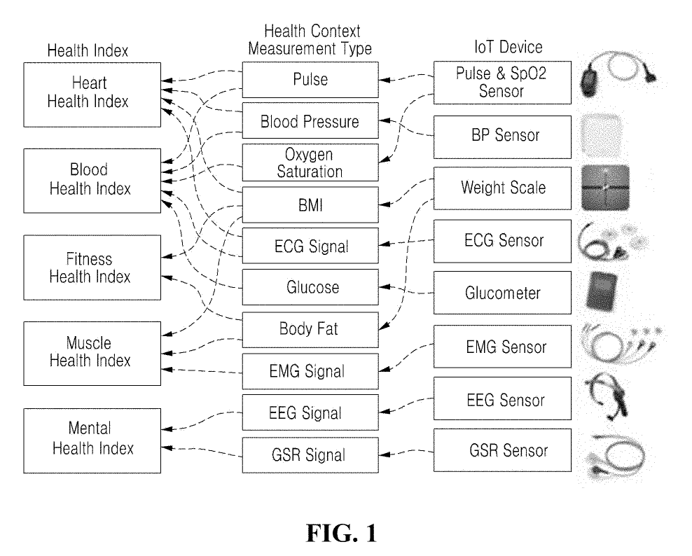

The universal health assessment model is constituted by health indexes that express the personal health status as figures in one aspect. One health index particularly represents the degree of the health status in a personal specific aspect. For example, a heart health index expresses the degree of the integral health status related with the heart as one figure. The universal health assessment model may be sufficiently used as an assistant means which assesses the personal health status. In addition, the health index is calculated by using the health context and a type of health index may vary according to health information, an analysis technique, and the like. FIG. 1 is a diagram illustrating an example of a health index which may be calculated by considering various types of health contexts collected from various IoT devices in a health assessment model.

For example, referring to FIG. 1, measurement values of health contexts for pulse, blood pressure, a body mass index (BMI), and an electrocardiogram (ECG) signal are required for calculating the heart health indexes.

As such, in order to calculate the health index, the health contexts are required and the health contexts are results of analyzing health information acquired from sensors of various IoT devices. Accordingly, the health index calculation matrix may be calculated by using various health information.

In the present invention, the health index is defined as consecutive values in a range of 0 to 10, and herein, the worst health status is defined as 0 and the best health status is defined as 10. Further, HealthIndex( )as a common function of the health index calculation matrix calculating the health index is defined as follows.

HI_Type represents a type of health index. CTX_List(HI_Type) is a list of health contexts used for calculating the health index. That is, CTX_List(HI_Type)=(CTX1, CTX2, . . . , CTXn).

W_List(HI_Type) is a weight of CTXi which is each health context of CTX_List(HI_Type). W_List(HI_Type) is a weighted list having the same number of items as CTX_List(HI_Type). A sum of weights returned to W_List( )becomes 1.

HealthIndex(HI_Type) is calculated using Equation below by using the terms defined above.

$$HealthIndex ( HI\_Type ) = 10 \times {\sum }_{i = 1}^{n = size ( CTX\_List ( HI\_Type ) )} ( CTX ( CTX\_List ( HI\_Type ) , i ) \times Weight ( W\_List ( HI\_Type ) , i ) )$$

As such, a specific health index is calculated by multiplying values of the related health contexts and a weight corresponding to the health context.

Values for the health contexts related to the pulse, the blood pressure, the BMI, and the ECG signal are required for calculating the heart health index, and since the values are not related with the heart health to the same degree, in order to calculate the heart health index by considering the importance, the heart health index is calculated by multiplying the corresponding weight by the values of the health context. The weight is set as a high weight by using a lot of medical literatures when each health context has a high relevance with the health index. For example, the abnormal degree of the heart can be easily determined through the value of the ECG signal, but only a possibility that the heart is not good may be estimated by the BMI value. Accordingly, in the heart health index, a higher weight than the BMI may be applied to the ECG signal, and the weights for the pulse, the blood pressure, the BMI, and the ECG signal may be applied as 0.3, 0.3, 0.1, and 0.3, respectively. When the weights are summed, the heart health index needs to be set to be 1.

The internet of things based health monitoring and assessment platform according to the present invention needs to be designed to be universally applied to acquire the health context from various types of IoT devices relating to the medical field and calculate a plurality of health indexes.

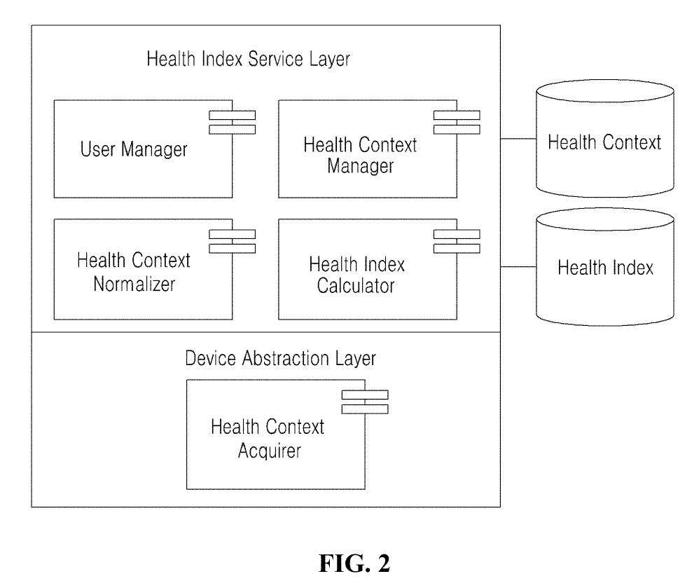

Accordingly, as illustrated in FIG. 2, the internet of things based health monitoring and assessment platform according to the present invention largely has a layer structure which is largely divided into a device abstraction layer and a health index service layer, and more particularly, includes a health context acquirer, a user manager, a health context manager, a health context normalizer, and a health index calculator.

The user manager is a component for storing and managing various information about the user. That is, identification information such as a user ID and a name, personal profile information, personal health-related information such as smoking and drinking, and the like are stored and managed.

The health context manager stores the health context acquired from the health context acquirer.

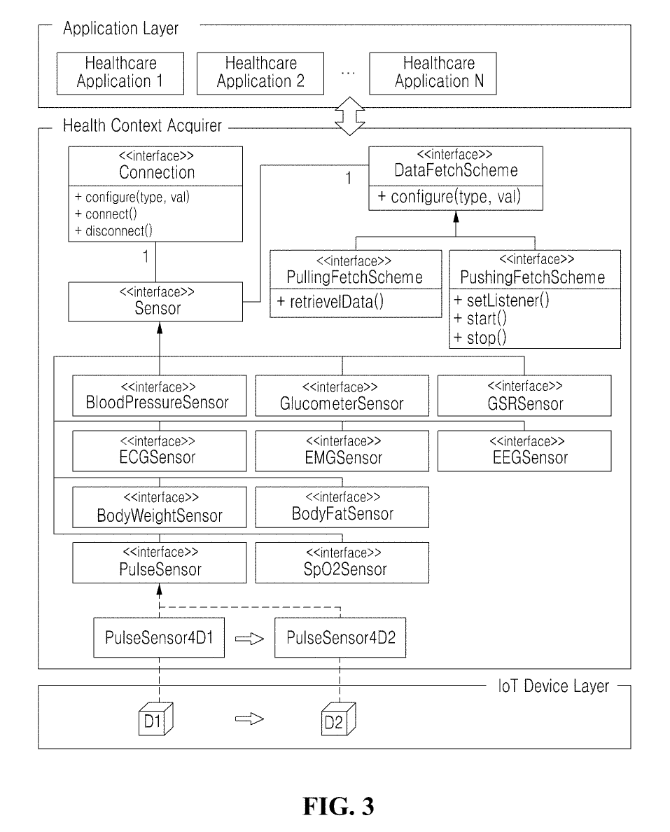

The health context acquirer acquires the health context from the sensors of various IoT devices. In FIG. 3, the design model of the health context acquirer is illustrated.

The IoT devices in the medical field have various differences in a program language and a health information acquiring method, and the platform of the present invention needs to acquire the health context from the IoT devices with heterogeneity and thus needs to be designed to be universally applied. Accordingly, in order to receive consistently the measurement values from various types of IoT devices, it is required to define various types of interfaces.

Referring to FIG. 3, a sensor interface defines a function required for reading and receiving the measurement values of the health context from the sensors provided in various types of IoT devices, a connection interface defines functions required for connecting sensors through a specific network protocol, and a data fetch scheme interface defines functions required for acquiring the measurement values of the health context from the sensor by using pulling and pushing data acquiring methods.

Since the interfaces are intended to specify functionality which needs to be implemented by various classes, the class needs to be created according to logic by implementing the interfaces to be suitable for a type of IoT device. Whenever a new type of IoT device is added, when a class following the interface is created, any type of IoT device may acquire and process the measurement value in the platform of the present invention.

That is, in FIG. 3, in the health context acquirer, when new IoT devices are verified and added to BloodPressureSensor, GlucometerSensor, GSRSensor, ECGSensor, EMGSensor, EEGSensor, BodyWeightSensor, BodyFatSensor, PulseSensor, and SpO2Sensor which define the interfaces for each IoT device, interfaces suitable for sensor types of the new IoT devices are added by expanding the connection interface and expanding one or all of lower interfaces of the data fetch scheme interface.

The health context normalizer and the health index calculator are constituent elements for analyzing and assessing the personal health status.

The health context normalizer is used for converting and normalizing the health context to values between 0 and 1.

For example, the blood pressure health context is determined according to systolic blood pressure and diastolic blood pressure, and the systolic blood pressure may be measured as a minimum value of 50 and a maximum value of 250 and the diastolic blood pressure may be measured as a minimum value of 35 and a maximum value of 140. The health statuses for the blood pressure are determined as low blood pressure, normal blood pressure, pre-high blood pressure, high blood pressure stage 1, high blood pressure stage 2, and the like according to the measurement values.

Further, the pulse health context means a current personal pulse and generally, the pulse is within a range of 60 to 100 times per minute, and the maximum pulse rate is 220 per minute and gradually reduced as getting older. The pulse of less than 60 times per minute is bradyrhythmia and the pulse of more than 100 times per minute is pyknocardia, and when even in a normal person, a situation where a sympathetic nervous system is accelerated, such as exercising, surprising, or angry and exciting occurs, the pulse may be increased to more than 100 times per minute.

As such, since the minimum value and the maximum value vary according to a type of health context, the degree of an effect on calculation of the specific health index for each type of health context. As a result, normalization to have a relatively high value when the value of each health context belongs to a normal range and a relatively low value when the value belongs to an abnormal range is required.

The normalization may be determined by using professional medical data, and for example, in Korea hypertension association or American heart association, a reference for the blood pressure health context is illustrated in Table 1 below.

TABLE 1

| | Systolic blood | Diastolic blood |
|---|---|---|
| Classification | pressure (mmHg) | pressure (mmHg) |
| Low blood pressure | <90 | <60 |
| Normal blood pressure | 90~119 | 60~79 |
| Pre-high blood pressure | 120~139 | 80~89 |
| High blood pressure stage 1 | 140~159 | 90~99 |
| High blood pressure stage 2 | 160~179 | 100~109 |

Based on the values illustrated in Table 1 above, when the systolic blood pressure and the diastolic blood pressure belong to a range of the normal blood pressure, the blood pressure health context is normalized to be converted to a value closer to 0 as farther way from the range of the normal blood pressure.

Equation below illustrates the normalization by using the systolic blood pressure and the diastolic blood pressure.

$$Normalized\_SYS ( {Measurement}_{SYS} ) = \{ \begin{matrix}{Measurement}_{SYS} < Min\_Normal \_SYS , & \frac{{Measurement}_{SYS} - {Min}_{SYS}}{Min\_Normal \_SYS - Min\_SYS} \\ Min\_Normal \_SYS \leq {Measurement}_{SYS} < Min\_PreHyper \_SYS & 1 \\ {Measurement}_{SYS} \geq Min\_PreHyper \_SYS & \frac{Max\_SYS - {Measurement}_{SYS}}{Max\_SYS - Min\_PreHyper \_SYS}\end{matrix} \\ Normalized\_DIA ( {Measurement}_{DIA} , ) = \{ \begin{matrix}{Measurement}_{DIA} < Min\_Normal \_DIA , & \frac{{Measurement}_{DIA} - Min\_DIA}{Min\_Normal \_DIA - Min\_DIA} \\ Min\_Normal \_DIA \leq {Measurement}_{DIA} < Min\_PreHyper \_DIA , & 1 \\ {Measurement}_{DIA} \geq Min\_PreHyper \_DIA , & \frac{Max\_DIA - {Measurement}_{DIA}}{Max\_DIA - Min\_PreHyper \_DIA}\end{matrix}$$

In Equation, MeasurementSYS and MeasurementDlA means a measurement value of the systolic blood pressure and a measurement value of the diastolic blood pressure, and based on Table 1 above, Min_Normal_SYS and Min_PreHyper_SYS are set to 90 and 120, respectively. Similarly, Min_Normal_DIA and Min_PreHyper_DIA are set to 60 and 80, respectively, and Min_SYS, Max_SYS, Min_DIA, and Max_DIA are set to 50, 250, 35, and 140, respectively, by using professional medical data. Accordingly, when two measurement values measured in the aforementioned Equation are averaged, the normalized blood pressure health context may be calculated.

The health index calculator calculates the value of the health index as a value between 0 and 1 when multiplying a weight by the value of the generalized health context and between 0 and 10 when multiplying 10 thereby by using the value of the health context converted in the health context normalizer.

Furthermore, the health index calculator stores and manages information on the health context and information on the corresponding weight related thereto for each health index and the information is managed in a separate j son format file approached by the health index calculator. In addition, in the case where a new type of health context is added, when the new type of health context and the corresponding weight are added to the health index calculator, the health index calculator may calculate the health index without correction of an existing source code.

The health index calculator calculates HealthIndex(HI_Type) for the heart health index by using Equation below.

$$HealthIndex ( HI\_Type ) = 10 \times {\sum }_{i = 1}^{n = size ( CTX\_List ( HI\_Type ) )} ( CTX ( CTX\_List ( HI\_Type ) , i ) \times Weight ( W\_List ( HI\_Type ) , i ) )$$

In this case, in the heart health index, the weights for the pulse, the blood pressure, the BMI, and the ECG signal may be applied as 0.3, 0.3, 0.1, and 0.3, respectively.

An example of a matrix calculating the heart-related health index is illustrated below by using the above Equation.

$$CTX\_List ( HeartHI ) = \{ BP , BMI , Pulse , HeartActivity \}$$

$$\begin{matrix}W\_List ( HeartHI ) = \{ W\_BP = 0.3 , W\_BMI = 0.1 , \\ W\_Pulse = 0.3 , W\_HeartActivity = 0.3 \}\end{matrix} \begin{matrix}Healthindex ( HeartHI ) = ( CTX ( BP ) \times Weight ( W\_BP ) + \\ CTX ( BMI ) \times Weight ( W\_BMI ) + \\ CTX ( Pulse ) \times Weight ( W\_Pulse ) + \\ CTX ( HeartActivity ) \times \\ Weight ( W\_HeartActivity ) ) \times 10 \\ = ( 0.8 \times 0.3 + 1 \times 0.1 + 1 \times 0.3 + 0.95 \times 0.3 ) \times 10 \\ = 9.25\end{matrix}$$

When considering the calculation value of the above matrix and the heart health index, it may be verified that the user has a normal pulse and a normal BMI, an ECG signal value (0.95) closer to the normal range, and blood pressure corresponding to the pre-high blood pressure (0.8) and it can be seen that the heart health index is calculated as 9.25 out of 10 to obtain a good health assessment result.

As such, when using the above matrix, other types of health indexes may be calculated in addition to five types of health indexes exemplified in FIG. 1.

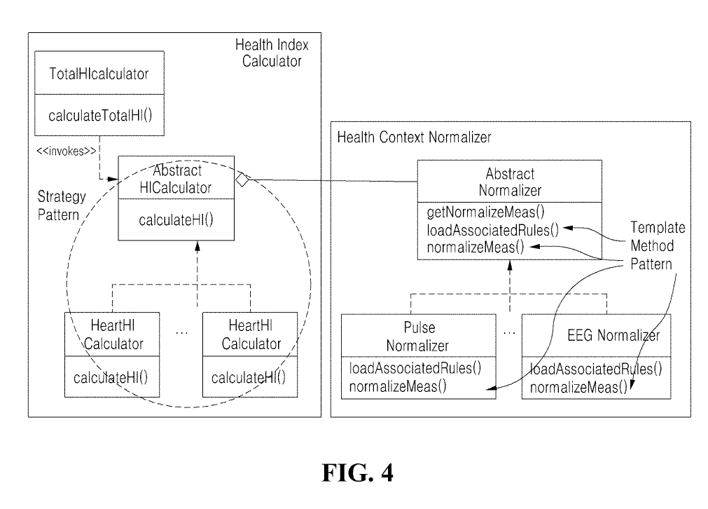

FIG. 4 illustrates a design model of the health context normalizer and the health index calculator according to the exemplary embodiment of the present invention. The health index is calculated differently according to a type of health context and each weight which are considered. That is, the logic calculating the health index varies according to the health context. To this end, the health index calculator is designed by applying a strategy pattern. The strategy pattern is a pattern which is applied well when a variety of algorithms are present, and the calculation of the health index varies according to a type of related health context to be designed by applying the strategy pattern.

Further, in the health context, an analysis method varies according to a type of data acquired from the sensor of the IoT device in the medical field. For example, when abnormality of cardiomotility is determined by using ECG data, a time data analysis method is used, but when a high blood pressure level context is identified through blood pressure data, if-else classification is used. Like the calculation of the health index, analysis logic of the health context varies according to a type of health context. To this end, the health context normalizer is designed by applying a template method pattern. All of the health contexts are analyzed through the same procedure, but since some procedures vary according to a type of health information, the health context normalizer is designed by applying a template method pattern.

In this case, in FIG. 4, an abstract normalizer is an abstract class defining operations required for normalization of all types of health contexts. A getNormalizeMeas( )operation performs a function of collecting health measurement data required for calculating the health context to be normalized currently and has the same logic regardless of a type of health context to be defined as a detailed operation. loadAssociatedRules( )performs a function of reading a rule required for normalization and normalizeMeas( )normalizes the health context according to the corresponding rule to return values between 0 and 1. The two operations are defined by an abstract method because implementation logic varies according to a type of health context. loadAssociatedRules( ) and normalizeMeas( )of a pulse normalizer inheriting the class implement logic required for normalizing the pulse health context.

Furthermore, an abstract HICalculator is an interface defining a standard API required for calculating the health index. When a new health index is added, a new class which implements the interface is added and a calculation matrix suitable for the added health index is included.

Further, Total HI is a result value calculated by considering all health statuses of the user. For example, when a heart health index is 9 and an obesity health index is 8, Total HI returns a value of 8.5 by considering them. The user may easily determine his current health status by showing the Total HI value.

The health index calculator performs a task for calculating the health indexes through the matrix defined above and manages a type CTX_List of health context and a weight W_List for each health context required for calculating one health index among them in a Key-Value form in the platform of the present invention.

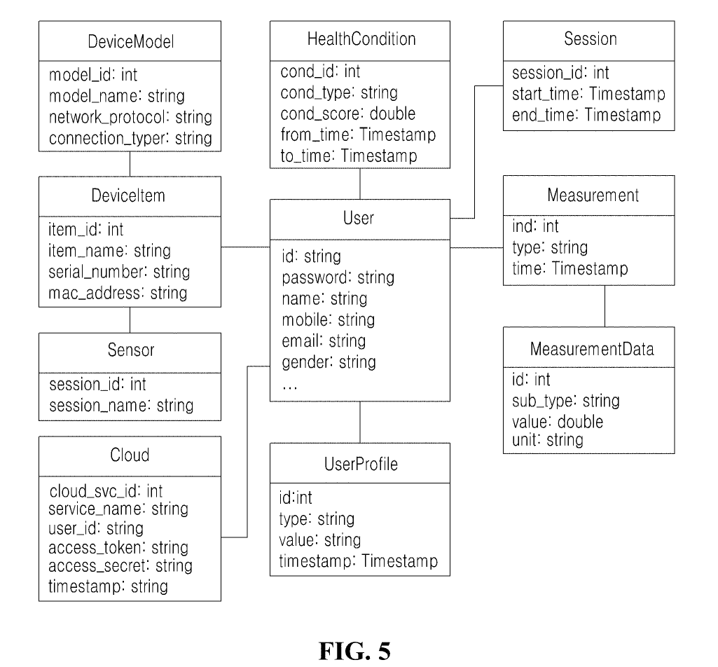

The health contexts acquired from the sensors of various IoT devices in the medical field with heterogeneity are various in formats and units. For example, in the ECG, values corresponding to P, Q, R, S, and T are acquired by a unit of ms and in the blood pressure, values of systolic blood pressure and diastolic blood pressure are acquired by a unit of mmHg, and thus it is difficult to pre-expect the formats and the units of the health contexts acquired from sensors of IoT devices to be added below. As such, in order to store various data acquired from the sensors of IoT devices in the medical field with heterogeneity, a database needs to be designed by considering versatility. In a local database, sensor information, user information, obtained health information, information on the assessed health status of the user, and the like are stored, and as described above, a database schema is designed so that various data may be separated and stored in a plurality of tables by defining 10 tables as illustrated in FIG. 5 by considering the versatility.

That is, referring to FIG. 5, a database schema is designed to separate and store common information of respective IoT devices, dependent information to an IoT device object, sensor information, and Cloud information through each table of a device model, a device item, a sensor, and a Cloud, and regardless of a type, all of the health contexts are managed in each table of Measurement and MeasurementData, and in the Measurement, the acquired health context information is stored and in the MeasurementData, the acquired health context value is stored. For example, information that the blood pressure value is acquired at a specific date is recorded in the measurement table, and in this cased, the values of the systolic blood pressure and the diastolic blood pressure and the measurement units are stored in the MeasurementData. When the two tables are used, even though a health context which is not currently considered is acquired, the structure of the database schema needs not to be changed.

As such, in order to store various health-related data acquired from the sensors of the IoT devices with heterogeneity, the database schema is designed by considering versatility, and thus, even though the IoT device is changed, meta information of the device is changed in the database and thus there is no change in the database schema.

Further, functionality provided by the platform according to the present invention is provided from a server through the API, and for example, the server provides 26 APIs in 12 Python modules and main APIs are illustrated in Table 2 below.

TABLE 2

| | Systolic blood | Diastolic blood |
|---|---|---|
| Classification | pressure (mmHg) | pressure (mmHg) |
| Low blood pressure | <90 | <60 |
| Normal blood pressure | 90-119 | 60-79 |
| Pre-high blood pressure | 120-139 | 80-89 |
| High blood pressure stage 1 | 140-159 | 90-99 |
| High blood pressure stage 2 | 160-179 | 100-109 |

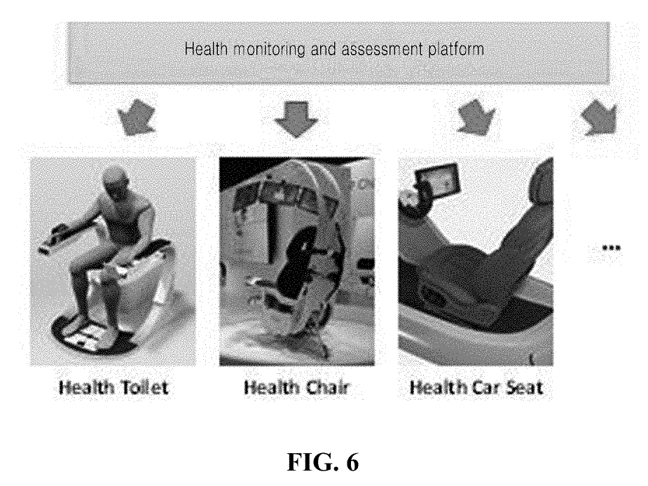

Furthermore, since the platform according to the present invention is not designed to be limited to a specific IoT device, the platform may be applied to development of various products which may use the acquired health information and the analyzed personal health status as illustrated in FIG. 6. Different types of sensors are attached for each product to acquire various health information whenever the user is in the bathroom, takes a rest in a chair, or drives on the car seat.

In order to monitor the personal health and assess the health status by using the platform of the present invention, first, whether a type of sensor of a IoT device which is not considered when designing the platform of the present invention and a type of health index are present is retrieved and verified, and when a new type of sensor is verified, an interface suitable for the corresponding device is added by expanding the connection interface of the health context acquirer and one or all of lower interfaces of the data fetch scheme interface. In addition, a class implementing the added interface is created to be added to the platform of the present invention. Further, when a new type of health index needs to be added, values suitable for a health index added to the CTX_List and the W_List are added. In addition, as illustrated in FIG. 4, a new class obtained by expanding an

AbstractNormalizer class and an AbstractHICalculator class of the health context normalizer is created to be added to the platform of the present invention. The newly added class may be easily added through an API defined in advance.

The internet of things based health monitoring and assessment platform according to the present invention can monitor and assess the personal health by using the health information acquired from various IoT devices to be a great help in personal health promotion, is universally designed to collect various health information from heterogeneous IoT devices, has an excellent extension to add a sensor of a new type of IoT device or a health context. Further, regardless of a type of IoT device, a system configured by hardware, software, and cloud for health monitoring and assessment using the various collected personal health information can be developed with low cost and high efficiency.

While the present invention has been shown and described in connection with the exemplary embodiments, it will be apparent to those skilled in the art that modifications and variations can be made without departing from the spirit and scope of the invention as defined by the appended claims.

What is claimed is:

1. An internet of things based health monitoring and assessment platform comprising:
a health context acquirer configured to acquire health contexts from sensors of one or more IoT devices;
a user manager configured to store and manage information on a user;
a health context manager configured to store and manage the health contexts acquired from the health context acquirer;
a health context normalizer configured to convert and normalize the values of the health contexts acquired from the health context acquirer to converted values between 0 and 1, in which when the value of the health context belongs to a normal range, the converted value is 1 and the converted value has a value closer to 0 as farther away from the normal range; and
a health index calculator configured to calculate health indexes expressing a body health status in one aspect, in which manage information on the health context for each health index and a weight set for each health context according to an importance in which each health context is related with the health index, and calculates the heat indexes by multiplying the converted value of the health context, which is converted by the health context normalizer by the weight.

2. The internet of things based health monitoring and assessment platform of claim 1, wherein the health context acquirer includes:
a sensor interface defining a function required to read and receive values of the health contexts from sensors provided in various types of IoT devices;
a connection interface defining functions required to connect the sensors through a specific network protocol; and
a data fetch scheme interface defining functions required for acquiring values of the health context from the sensor of the IoT device by using pulling and pushing data acquiring methods.

3. The internet of things based health monitoring and assessment platform of claim 2, wherein the health context acquirer adds an interface suitable for a new sensor type by extending the connection interface and extending one or all of lower interfaces of the data fetch scheme interface when a new type sensor of the IoT device is verified and added.

4. The internet of things based health monitoring and assessment platform of claim 1, wherein the health context normalizer includes:
a collection unit collecting health measurement information required for calculation of the converted value of the health context to be normalized;
a load unit loading a rule required for normalization; and
a normalizer normalizing a value of the health context suitable for the rule to convert the value to a converted value between 0 and 1.

5. The internet of things based health monitoring and assessment platform of claim 1, wherein the health index calculator calculates the value of the health index as a value between 0 and 1 when multiplying a weight by the value converted in the health context normalizer and between 0 and 10 when multiplying 10 thereby again.

6. The internet of things based health monitoring and assessment platform of claim 1, wherein the health context normalizer is designed by applying a template method pattern, and the health index calculator is designed by applying a strategy pattern.

7. The internet of things based health monitoring and assessment platform of claim 1, wherein the health index calculator calculates a health index without correction of an existing source code when the new type of health context and the corresponding weight are added, in the case where a new type of health context is added.

8. The internet of things based health monitoring and assessment platform of claim 1, wherein the health index calculator calculates and averages a plurality of health index values, respectively to determine the entire health status of the user.

9. The internet of things based health monitoring and assessment platform of claim 1, wherein the platform has a database schema structure in which various data acquired from the sensors of the IoT devices with heterogeneity are separately stored in a plurality of tables by considering versatility, common information of IoT devices, dependent information to an IoT device object, and sensor information are separately stored in tables of a device model, a device item, and a sensor, respectively, and the acquired health context information, the acquired health context value, and a measurement unit are separately stored in each table of Measurement and MeasurementData.
